(19) United States
(12) Patent Application Publication
(10) Pub. No.: US 2024/0051764 A1
(43) Pub. Date: Feb. 15, 2024

(54) CONVEYOR DEVICE WITH OPERATION-MONITORING SYSTEM

(71) Applicant: HOMAG GmbH, Schopfloch (DE)

(72) Inventors: Rolf HOFBAUER, Gäufelden (DE); Yimin GAN, Rottenburg am Neckar (DE); Harald RIEGER, Waldachtal (DE)

(21) Appl. No.: 18/268,155

(22) PCT Filed: Dec. 14, 2021
(86) PCT No.: PCT/EP2021/085706

§ 371 Date: Jun. 16, 2023

(30) Foreign Application Priority Data
Dec. 16, 2020 (DE) 10 2020 133 719.1

(51) Int. Cl. B65G 43/02; B65G 39/20

(52) U.S. Cl. CPC B65G 43/02; B65G 39/20; B65G 2203/0275; B65G 2203/045; B65G 2203/044

(57) ABSTRACT

The invention relates to a conveyor device (100) for transporting an in particular plate-like workpiece (W), in particular in a processing machine. Such a conveyor device (100) for transporting an in particular plate-like workpiece (W) comprises a revolving conveyor element (110) which is guided by means of running rollers (112) and/or guide rollers, and a sensor device (140) for detecting measurement values for monitoring the operation of the conveyor element (110).

### TECHNICAL FIELD

The invention relates to a conveyor device for transporting an in particular plate-like workpiece, in particular in a processing machine. Such a conveyor device can be used in the field of the furniture or building elements industry.

### PRIOR ART

Various conveyor devices are known for the transport of plate-like workpieces. For example, conveyor chains are used, as these are described in EP 1 878 674 A1. Such a conveyor chain comprises a chain link which in turn comprises running rollers and a transverse guide. Furthermore, a ferromagnetic material can be provided in the running direction between a pair of running rollers and another running roller in order to ensure smooth running at high throughput speeds by means of a magnetic force exerted on the chain link.

A conveyor device is also known from DE 10 2014 218 641 A1, which comprises a carrier and a conveyor belt revolving in the carrier and a guide means. The conveyor belt comprises a profile in the extension direction, which profile engages with the guide means. This configuration makes it possible to provide a conveyor device that enables precise alignment of workpieces with respect to the processing tools at a high conveying speed.

### DESCRIPTION OF THE INVENTION

The invention aims to provide a conveyor device that has increased operational reliability and with which operating and/or maintenance costs can be further reduced.

The subject matter of claim 1 provides a corresponding conveyor device. Further preferred embodiments are specified in the dependent claims.

The conveyor device which is configured to transport an in particular plate-like workpiece comprises: a revolving conveyor element which is guided by means of running rollers and/or guide rollers, and a sensor device for detecting measurement values for monitoring the operation of the conveyor element.

Monitoring the operation of the conveyor element can, for example, monitor the condition of the conveyor element and/or components for moving/guiding the conveyor element.

The conveyor device according to the invention makes it possible to monitor a condition of the conveyor element. In particular, the sensor device can be used to monitor the condition of a running roller and/or guide roller, in particular a bearing of a running roller and/or guide roller.

With the conveyor device according to the invention, the service life can be increased and predictive maintenance can be set up. The latter reduces maintenance costs through early detection of faults and thus early ordering and planning of production downtime for maintenance/repair. Furthermore, it is possible to quantitatively evaluate the assembly condition of the conveyor device during machine inspection.

According to one embodiment, the sensor device is configured to detect measurement values for evaluating a condition of a running roller and/or a guide roller.

This approach is based on the finding that running rollers and/or guide rollers, in particular their bearings, are highly stressed components of a conveyor device. If such a conveyor device comprises a conveyor chain, an outer ring can become loose, for example, when a bearing of a running roller and/or guide roller is worn. This in turn can lead to a failure of the conveyor chain during operation and thus to expensive consequential damage. This would result in unpredictable production downtimes and financial losses for the user.

This means, for example, that maintenance work can be planned in advance as wear and tear is detected at an early stage. Long-term or short-term monitoring results in information that can be evaluated and, for example, signals can be communicated to the machine control, machine operator or cloud.

It is preferred that the sensor device is arranged in a deflection area of the conveyor device. Based on this arrangement, extremely reliable measurement results can be achieved. According to a further embodiment, the sensor device can be attached to a guide track or integrated into a guide track, wherein the guide track extends from deflection area to deflection area.

According to a further embodiment, the sensor device is attached to a deflection plate, wherein it is preferred that the deflection plate is supported by means of an actuator, in particular a spring-damper mechanism. The arrangement on or in the area of the deflection plate enables extremely reliable measurement results, in particular if the sensor device for monitoring the operation of the conveyor element comprises a microphone with which the operation of the conveyor element can be monitored by means of an airborne sound measurement.

According to a further embodiment, the sensor device comprises a microphone. In this way, an airborne sound measurement can be used to monitor operation of the conveyor element. It is preferred that the sensor device further comprises a temperature sensor in order to determine an ambient temperature in the area of the mounting location of the temperature sensor. The temperature determined by the temperature sensor can be included in the evaluation of the measurement values detected by the microphone. In particular, measurement values of the microphone can be evaluated by means of the temperature values.

According to a further embodiment, the sensor device comprises a strain sensor, an acceleration sensor, a torque sensor and/or an optical sensor. One of the above sensors or a combination thereof may be used in combination with the aforementioned microphone and/or the temperature sensor.

By means of a strain sensor, deformations resulting from operation of the conveyor element can be determined. With increasing wear, such strain can increase.

An acceleration sensor can be used to determine operational accelerations that change depending on the condition of the conveyor device.

By means of a torque sensor, the effort required to operate the conveyor element can be determined. This can also be used to evaluate the operation of the conveyor element.

An optical sensor can be used to detect a geometric change of the conveyor element or its arrangement (e.g. skewed) in the deflection area, in particular on the deflection plate.

The conveyor element can be designed as a conveyor chain comprising a plurality of chain links. It has been shown that the tension of the chain links is increased in particular in the deflection area, preferably in the area of a deflection plate. This enables extremely reliable measurement results, due to the high running smoothness, when the sensor device comprises a microphone, for example.

Furthermore, it is preferred that the chain links comprise a ferromagnetic material, so that the chain links are attracted and thus tensioned in the deflection area, in particular in the area of the deflection plate. Due to this design, an increased running smoothness is achieved in the deflection area.

According to a further embodiment, the conveyor device comprises a top pressure which comprises a belt revolving around a drive roller and a deflection roller. With the top pressure, workpieces can be held in a tensioned state during movement by means of the conveyor element, so that processing of the exposed areas, in particular the narrow surface, is possible.

The invention further relates to a processing machine having a processing unit for processing a workpiece and a conveyor device according to any one of the preceding aspects. Such a processing machine can be used in particular to process a narrow surface of a workpiece moved by the conveyor device.

The arrangement of the sensor device in an area remote from the processing unit(s), for example in the deflection area, reduces interference.

The processing machine can comprise a control device which is configured to monitor an operation of the conveyor element based on the measurement values detected by the sensor device. In particular, a condition of a running roller and/or a guide roller is monitored, e.g. by means of frequency analysis. Furthermore, the measurement values detected by the sensor device can be used to move the conveyor element into such a position in the event of maintenance that a running roller and/or a guide roller can be maintained or removed.

According to one embodiment, the control device is configured to monitor an operation of the conveyor element in such a way that a running roller and/or a guide roller can be moved to a specified position. In particular, the conveyor element can be moved such that a running roller and/or a guide roller is positioned in a change position. This facilitates corresponding maintenance work.

Furthermore, the control device can comprise a memory device which is configured to store the measurement values detected by the sensor device, to prepare them for further processing and/or to evaluate them.

For example, the determined measurement values can be processed, in particular filtered, for transmission to a central memory device, such as a cloud.

According to a further aspect, the invention provides a system which comprises a conveyor device according to any one of the preceding aspects or a processing machine according to the above embodiments. The system further comprises a central memory device, in particular a cloud, which is configured to store and/or evaluate the measurement values detected by the sensor device.

According to a method for operating a conveyor device, measurement values are determined for monitoring the operation of the conveyor element. A conveyor device according to any one of the previously mentioned aspects or a processing machine according to any one of the aforementioned embodiments can be used for said method.

### BRIEF DESCRIPTION OF THE DRAWINGS

Further features and advantages are shown in the following description of embodiments with reference to the corresponding drawings.

FIG. 1 shows a schematic side view of a conveyor device according to the invention.

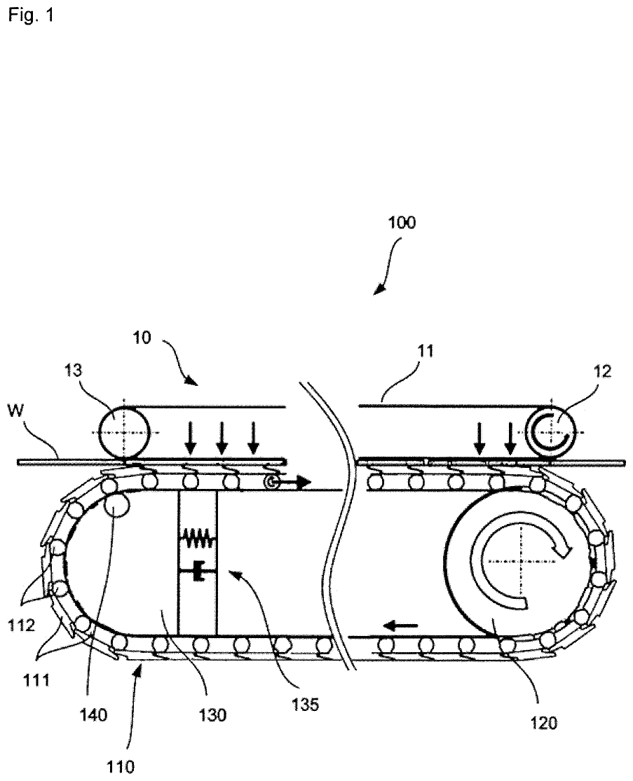

FIG. 2 shows a schematic front view of the conveyor device shown in FIG. 1.

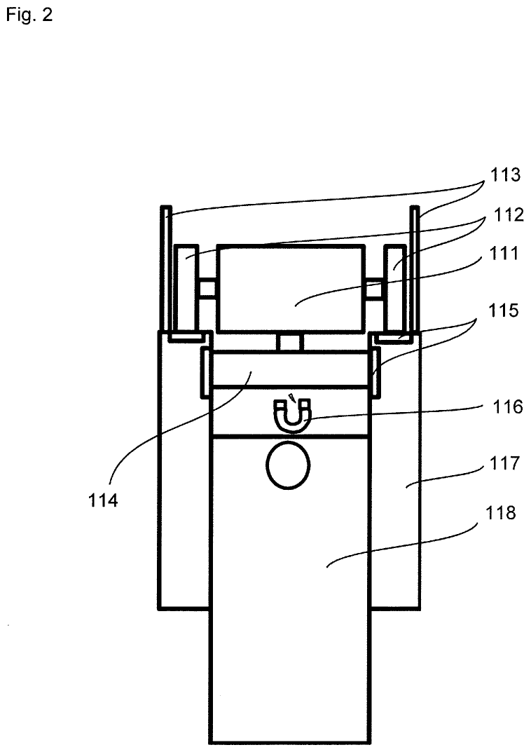

### DESCRIPTION OF EMBODIMENTS

Identical reference numbers listed in different figures designate identical, corresponding or functionally similar elements.

A conveyor device 100 according to the embodiment is in particular used for transporting plate-like workpieces W, as these are processed in the woodworking industry or in furniture manufacturing. For example, it may be furniture fronts, wall or ceiling panels, floor panels or the like.

The conveyor device 100 comprises a conveyor chain 110 (conveyor element) endlessly revolving around a carrier system, which comprises a plurality of chain links 111. The chain links 111 are hinged together and supported by running rollers 112. Shielding plates 114 are provided laterally of the running rollers 112 to shield the area of the conveyor chain 110 from the outside.

Furthermore, a respective chain link 111 is connected to at least one guide roller 114 which is provided in the vertical direction below the chain link 111 and enables the transport chain 110 to be guided in the direction of movement. Thus, the transport chain 110 is maintained in a straight line during operation of the conveyor device 100.

The assembly of the chain link 111, running rollers 112, and guide roller 114 is supported relative to guide plates 117 attached to or formed with a base body 118. For this purpose, spring belt steels 115 are flanged into the guide plates 117, which extend in the direction of movement of the conveyor chain 110 and have increased abrasion resistance. The running rollers 112 are in contact with a respective spring belt steel 115. Adjacent to the guide roller 114, a spring belt steel 115 is also provided on one side in each case, which provides high wear resistance in the event of contact of the guide roller 114 when the conveyor chain 110 is guided laterally.

A magnetic force generating device 116 is provided in an area between the base body 118 and the guide roller 114 to ensure tightening of the chain link in the direction of the base body 118 by means of magnetic forces. In this way, a high running smoothness of the conveyor chain 110 is made possible.

The base body 118 is part of the carrier system around which the transport chain 110 revolves. A drive roller 120 (also referred to as a “sprocket”) is provided at an end portion of the carrier system, such as the discharge portion of the conveyor device 100. On a side of the transport system opposite to the drive roller 120, for example an inlet area of the conveyor device 100, a deflection plate 130 is formed, which is used as a chain tensioner by means of a spring-damper mechanism 135.

In the embodiment, the conveyor device 100 further comprises a top pressure 10 which comprises a belt 11 revolving around a drive roller 12 and a deflection roller 13. When moving a workpiece W with the conveyor device 100, the workpiece W enters a conveying gap between the top pressure 10 and the revolving conveyor chain 110 and is thus moved in the transport direction in the tensioned state.

In the area of the deflection plate 130, a microphone 140 is provided on the base body 118 as a sensor device or element thereof. During operation of the conveyor device 100, the microphone 140 determines measurement values from airborne sound, which can be evaluated by a control device (not shown) of the conveyor device 100 or a control device of a processing machine (not shown), which comprises the conveyor device 100.

The measurement values determined by the microphone 140 can be used to evaluate the running rollers 112 and/or the guide roller 114, in particular a bearing of the running rollers 112 and/or the guide roller 114. In particular, it is possible to determine a defective running roller 112 and/or guide roller 114 by means of frequency analysis. In the event of maintenance, the position of the running rollers 112 and/or the guide roller 114 can also be evaluated, and thus the transport chain 110 can be moved and positioned in such a way that the defective running roller/guide roller comes to a stop in a specific assembly area.

During operation of the conveyor device 100, the measurement values determined by the microphone 140 can be processed as follows. The measurement values detected by the microphone 140 are transmitted to the aforementioned control device which is configured to perform frequency analysis. The measurement and characteristic values are stored in a memory device, for example a cloud, so that the stored data can be further evaluated using a wear model. This also makes it possible for the user to visualize the current condition of the transport chain 110 and to trigger a maintenance event in the event that a certain level of wear is reached. It is also possible to start an automatic spare parts order and service request.

In the course of maintenance, the specific damaged running roller/guide roller can be detected and replaced accordingly. In a test run, the ongoing evaluation of the data detected by the microphone 140 can be used to secure the repair measure on site.

Although the embodiment relates to a conveyor device 100 comprising a revolving conveyor chain 110, a conveyor device according to a further embodiment may also comprise a conveyor belt.

According to further embodiments, the sensor device can also be formed as or comprise a temperature sensor, a torque sensor, a strain sensor or an optical sensor. In particular, one or more of said sensors can be combined with said microphone in a sensor device in order to further increase the relevance of the detected measurement values.

The combination of a microphone and a temperature sensor has been found to be particularly advantageous. For example, an increased sound level and an increased temperature gradient can be used to determine increased wear or even higher assembly tolerances or excessive skewing of the conveyor chain 110. A wear detection of the chain guide track, for example chatter marks in the area of the deflection plate, can also be detected.

It is obvious to the person skilled in the art that individual features each described in different embodiments can also be implemented in a single embodiment, provided they are not structurally incompatible. Similarly, various features described within the scope of a single embodiment may also be provided in multiple embodiments individually or in any suitable sub-combination.

1. A conveyor device for transporting a workpiece, comprising:
a revolving conveyor element which is guided by one or more rollers, and
a sensor device for monitoring the operation of the conveyor element.

2. The conveyor device according to claim 1, wherein the sensor device is configured to detect measurement values for evaluating a condition of the one or more rollers.

3. The conveyor device according to claim 1, wherein the sensor device is arranged in a deflection area of the conveyor device.

4. The conveyor device according to claim 1, wherein the sensor device is formed on or attached to a deflection plate.

5. The conveyor device according to claim 1, wherein the sensor device comprises at least one of a microphone, a temperature sensor, a strain sensor, an acceleration sensor, a torque sensor or an optical sensor.

6. The conveyor device according to claim 1, wherein the conveyor element is a conveyor chain which comprises a plurality of chain links.

7. The conveyor device according to claim 6, wherein the chain links comprise a ferromagnetic material.

8. The conveyor device according to claim 1, further comprising a top pressure which comprises a belt revolving around a drive roller, and a deflection roller.

9. Processing A processing machine having
a processing unit for processing a workpiece;
a revolving conveyor element which is guided by one or more rollers; and
a sensor device for monitoring the operation of the conveyor element.

10. The processing machine according to claim 9, further comprising a control device which is configured to monitor an operation of the conveyor element based on measurement values detected by the sensor device.

11. The processing machine according to claim 10, wherein the control device is configured to monitor a condition of the one or more.

12. The processing machine according to claim 10, wherein the control device is configured to monitor an operation of the conveyor element for adjusting a position of the one or more rollers.

13. The processing machine according to claim 10, further comprising a central memory device, in particular for storing or evaluating the measurement values detected by the sensor device.

14. A method for operating a conveyor device, wherein the conveyor device comprises a revolving conveyor element guided by one or more rollers and a sensor device, the method comprising detecting measurement values for monitoring an operation of the conveyor element.

15. The method according to claim 14, wherein the step of detecting measurement values further comprises evaluating a condition of the one or more rollers.

16. The conveyor device according to claim 1, wherein one or more of the rollers comprise running rollers.

17. The conveyor device according to claim 1, wherein one or more of the rollers comprise guide rollers.

18. The conveyor device according to claim 4, wherein the deflection plate is supported by an actuator.

19. The conveyor device according to claim 11, wherein the control device is configured to perform frequency analysis to monitor the condition of the one or more rollers.
